(19) United States
(12) Patent Application Publication
(10) Pub. No.: US 2003/0085852 A1
(43) Pub. Date: May 8, 2003

(54) System integration chips for display and memory control

(76) Inventor: Ho-Hsing Yang, Hsinchu (TW)

Correspondence Address: HAVERSTOCK & OWENS LLP, 162 NORTH WOLFE ROAD, SUNNYVALE, CA, 94086, US

(21) Appl. No.: 10/256,062

(22) Filed: Sep. 25, 2002

(30) Foreign Application Priority Data
Sep. 27, 2001 (TW) 90216577

(51) Int. Cl. G09G 1/02; G09G 3/18

(52) U.S. Cl. 345/53; 345/27

(57) ABSTRACT

A system integration chip for display and memory control applied to a card recognition module is provided. The card recognition module includes a module casing, a memory card, an oscillator, a storage, and a display. The system integration chip is disposed in the module casing for recognizing a data stored in the memory card and storing the data in the storage, and the data is converted into a signal by the oscillator and then displayed by the display. The system integration chip includes a memory card controller electrically connected to the memory card and the storage to control read and write of the data stored in the memory card, a data bus controller electrically connected to the memory card, the storage, and the display to control a transmission route for the data; and a display timing controller electrically connected to the display to control the display condition of the data,

### FIELD OF THE INVENTION

This invention relates to a system integration chip, and more particularly to a system integration chip applied to a card recognition module for display and memory control.

### BACKGROUND OF THE INVENTION

The experiences and achievements accumulated by the forefathers cause the advancement of mankind nowadays. Hieroglyphic characters, concrete buildings, or even the imaginary pictures, all belong to the visual creations. And in order to record the data image more conveniently. it comes to the birth of the camera that can pick up the image immediately.

In the past, the traditional camera is only capable of taking a photo, and must have the steps of developing a film to show the contents of the images. Because of the advancement of technology, there comes the digital camera. The best benefit of the digital camera is using a repeatable storing media to record the image. This repeatable storing media can be read by a computer or other modules (e.g., photo printer or PDA), only if an internal connector or an externally connected card recognition module is available.

Because the demand of the digital camera or the personal digital assistance (PDA) is raised, the growth of the portable storing media is also raised. Thus, the relevant card recognition module become the essential equipment but still needs to be connected to the computer or other modules (e.g., photo printer or PDA) for recognizing the image data in a storing media. Please refer to FIG. 1 showing the circuit structure of the display module connected to the card recognition machine in the prior art. The card recognition module 11 comprises a processor (generally a digital signal processor (DSP)) 14, a random-access memory (RAM) 15, and an oscillator (OSC) 16. Further, the display module 12 comprises a timing controller 17, a data buffer 18, and a display 19. When the portable memory card 13 is plugged into the processor 14, the image data in the portable memory card 13 can be stored in the RAM 15 in advance through the processor 14. Then, the image data in the portable memory card 13 becomes a digital signal to be transmitted to the display module 12 through the processor 14 and the oscillator 16. When the digital signal is transmitted to the display module 12, the digital signal w ill be converted into an image data which can be read by the display 19 through the horizontal/vertical scanning signals controlled by the timing controller 17. Finally, the image data is transmitted through the data buffer 18 to the display 19.

As described above, it is easy to recognize any data stored previously in the portable memory media through the card recognition machine, but the image data must be connected to the display to be displayed as a picture for viewing. Presently, the main emphasis of the electric equipment is how to reduce the components and diversify the functions, and the main purpose is how to integrate plural electric equipments effectively.

Because of the technical defects described above, the applicant keeps on carving unflaggingly to develop “system integration chips for display and memory control” through wholehearted experience and research.

### SUMMARY OF THE INVENTION

It is an object of the present invention to provide a system integration chip applied, to a card recognition module, so that the card recognition module can have the functions of memory card recognizing and displaying through an integrated chip at the same time.

It is another object of the present invention to provide a card recognition module to get to the purposes of reducing the electric components and making the functions more complete.

It is another further object of the present invention to provide a removable disc to carry the data about 8-32 MB to overcome the inconvenience through 1.44 MB diskettes or the Internet.

The present invention provides a system integration clip for display and memory control applied to a card recognition module. The card recognition module includes a module casing, a memory card, an oscillator, a storage, and a display. The system integration chip is disposed in the module casing for recognizing a data stored in the memory card and storing the data in the storage, and the data is converted into a signal by the oscillator and then displayed by the display. The system integration chip includes a memory card controller electrically connected to the memory card and the storage to control read and write of the data stored in the memory card, a data bus controller electrically connected to the memory card, the storage, and the display to control a transmission route for the data, and a display timing controller electrically connected to the display to control the display condition of the data.

Preferably, the display is a RAM.

Preferably, the memory card is a portable memory card.

Preferably, the module casing is a single module casing.

Preferably, the recognition module includes an electric equipment.

Preferably, the electric equipment is a computer.

Preferably, the memory card is capable of transferring the data to the computer by the system integration chip.

Preferably, the computer is capable of transferring another data in the computer to the memory card by the system integration chip.

Preferably, the electric equipment is a printer.

Preferably, the contents of the data in the memory card is capable of being printed by the printer.

Preferably, the display timing controller provides a horizontal scanning signal and a vertical scanning signal.

In accordance with an aspect of the present invention, a card recognition module includes a memory card, an oscillator, a storage, and a display, wherein the data in the memory card is recognized and stored in the storage, the data is converted to the signal by the oscillator, and the signal is displayed by the display. The card recognition module includes a module casing; and system integration chip disposed in the module casing. The system integration chip includes a memory card controller electrically connected to the memory card and the storage to control read and write of the data stored in the memory card, a data bus controller electrically collected to the memory card, the storage, and the display to control a transmission route for the data, and a display timing controller electrically connected to the display to control the display condition of the data.

Preferably, the storage is a RAM.

Preferably, the memory card is a portable memory card.

Preferably, the module casing is a single module casing.

Preferably, the card recognition module is an electric equipment.

Preferably, the electric equipment is a computer.

Preferably, the memory card is capable of transferring the data to the computer by the system integration chip.

Preferably, the computer is capable of transferring another data in the computer to the memory card by the system integration chip.

Preferably, the electric equipment is a printer.

Preferably the contents of the data in the memory card is capable of being printed by the printer.

Preferably, the display timing controller provides a horizontal scanning signal and a vertical scanning signal.

In accordance with an aspect of the present invention, a card recognition module includes a memory card for storing data, a memory card controller for recognizing the data in the memory card and then storing the data in the storage an oscillator electrically connected to the memory card controller for converting the data to a signal, a data bus controller electrically connected to the memory card controller to control the transmission route of the data, a display timing controller electrically connected to the display to control the display condition of the data, and a display electrically connected to the display timing controller to display the data into an image.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematical view showing the circuit structure of the display module connected to the card recognition machine in the prior art;

FIGS. 2A˜2C are schematical views showing the circuit structure of the card recognition machine adopting the system integration chip in the

FIG. 2D is a schematical view showing the horizontal scanning signal and the vertical scanning signal in the present invention;

FIG. 2E is a schematical view showing, the circuit structure of the electric equipment connected to the card recognition machine adopting the system integration chip in the present invention; and

FIG. 3 is a flow chart showing the card recognition method of the card recognition machine adopting the system integration chip in the present invention.

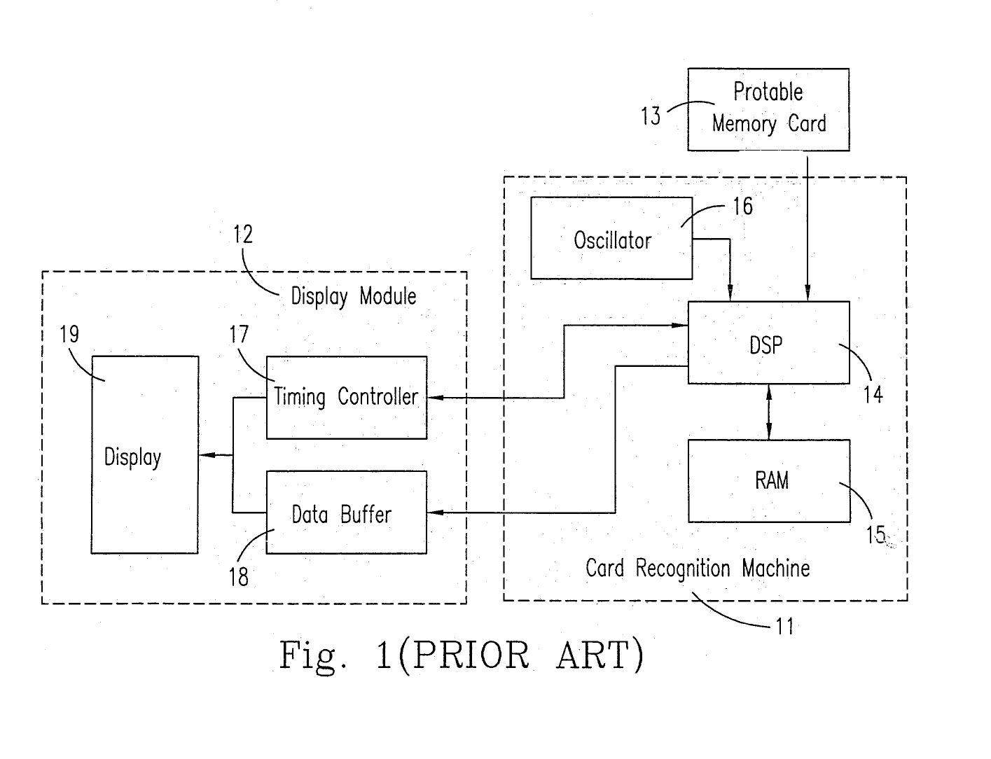

### DETAILED DESCRIPTION OF THE PREFERRED EMBODIMENT

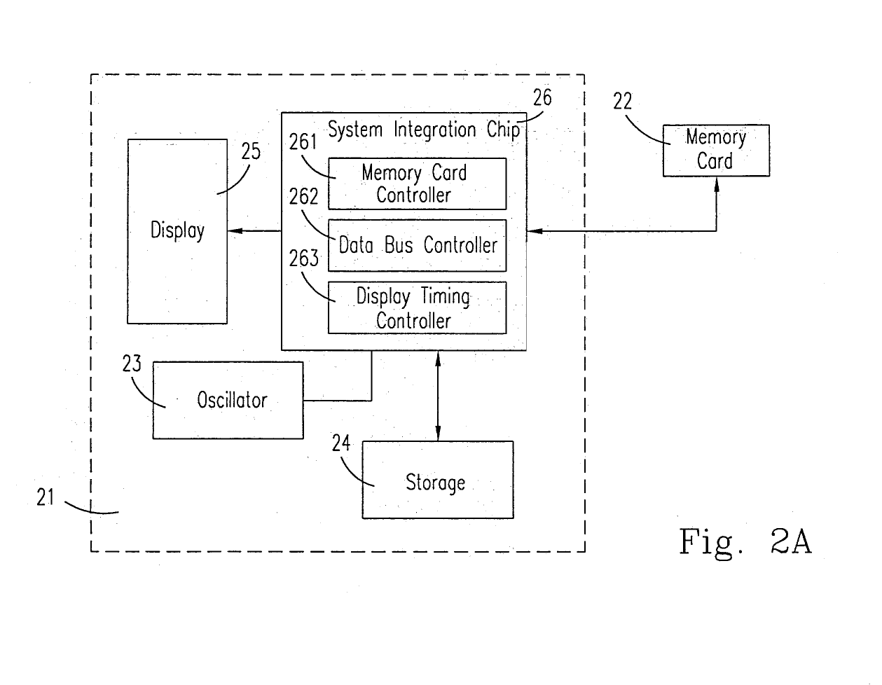

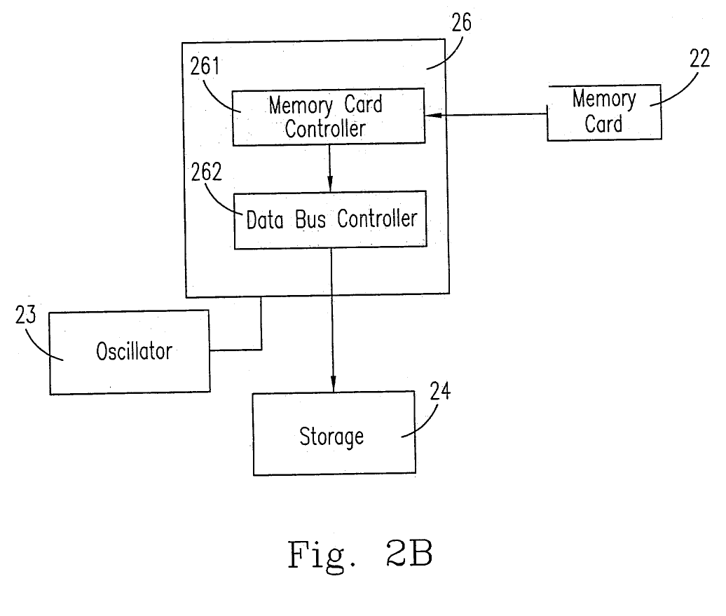

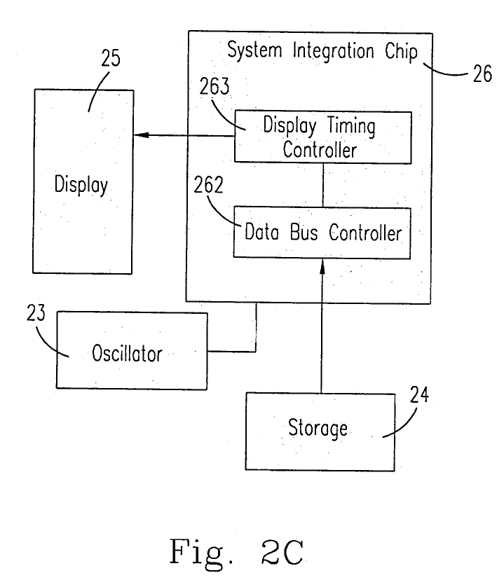

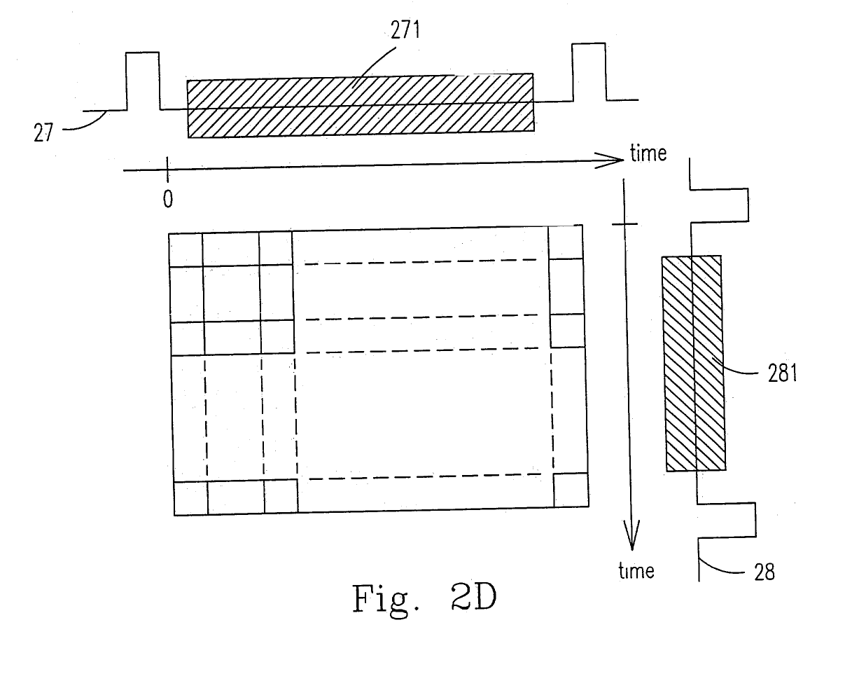

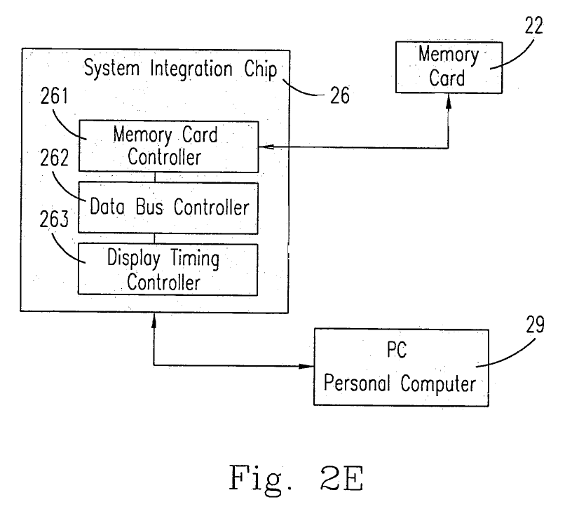

Please refer to FIG. 2A schematically showing the circuit structure of the card recognition machine with the system integration chip in the present invention. The present invention is a system integration chip applied to the card recognition machine. The card recognition machine includes a module casino 21, a memory card 22 (being a portable memory card), an oscillator 23, a storage 24 (being a random-access memory (RAM)), and a display 25. The module casing 21 is a single module casing and the system integration chip 26 is covered thereby. The system integration chip 26 has a memory card controller 261, a data bus controller 262, and a display timing controller 263.

Please refer to FIG. 2B schematically showing the routes of transmitting the image data to the storage through the memory card in the card recognition machine adopting the system integration chip in the present invention. The memory said 22 receives the image data stored in the memory card 22 through the memory card controller 261 in the system integration chip 26. Moreover, the image data is stored in the storage 24 designated by the data bus controller 262 in the system integration chip 26. Please refer to FIG. 2C schematically showing the routes of transmitting the image data to the display through the storage of a preferred embodiment in the present invention. Upon trying to shove the picture of the image data through the display, the image data stored previously in the storage 24 must be transmitted to the data bus controller 262, and the transferring routes of the image data are from the storage to the display directly by the data bus controller 262. Moreover, the data can be converted into a signal by the oscillator (being a digital signal in a preferable embodiment of the present invention) and expressed through the combination of the numbers 1 and 0 (named as byte, being numeral in the binary system). Furthermore, it is based on a horizontal scanning signal 27 and a vertical scanning signal 28 (as shown in FIG. 2D) of the display timing controller 263 in the system integration chip 26 to read in these data and recombine them as an image file, wherein the horizontal scanning signal 27 and the vertical scanning signal 28 both comprises effective development regions 271 and 281. Consequently, the signal in the effective development regions 271 and 281 can be displayed as a picture through the display 25.

Another preferable embodiment in the present invention, as shown in FIG. 2E. schematically showing the circuit structure of the electric equipment connected to the card recognition module adopting the system integration chip in the present invention. The electric equipment can be a personal computer 29, wherein the personal computer 29 can transmit the image data to the memory card 22 by connecting the memory card 22 to the system integration chip. First, the image data will be converted into the data model capable of being accessed by the memory card 22 through the display timing, controller 263 and the transmitting routes to the memory card 22 are designated by the data bus controller 262. Then the data storage action is completed by the memory card controller 261. If the card recognition module is connected to a printer, the image data in the memory card can be printed out.

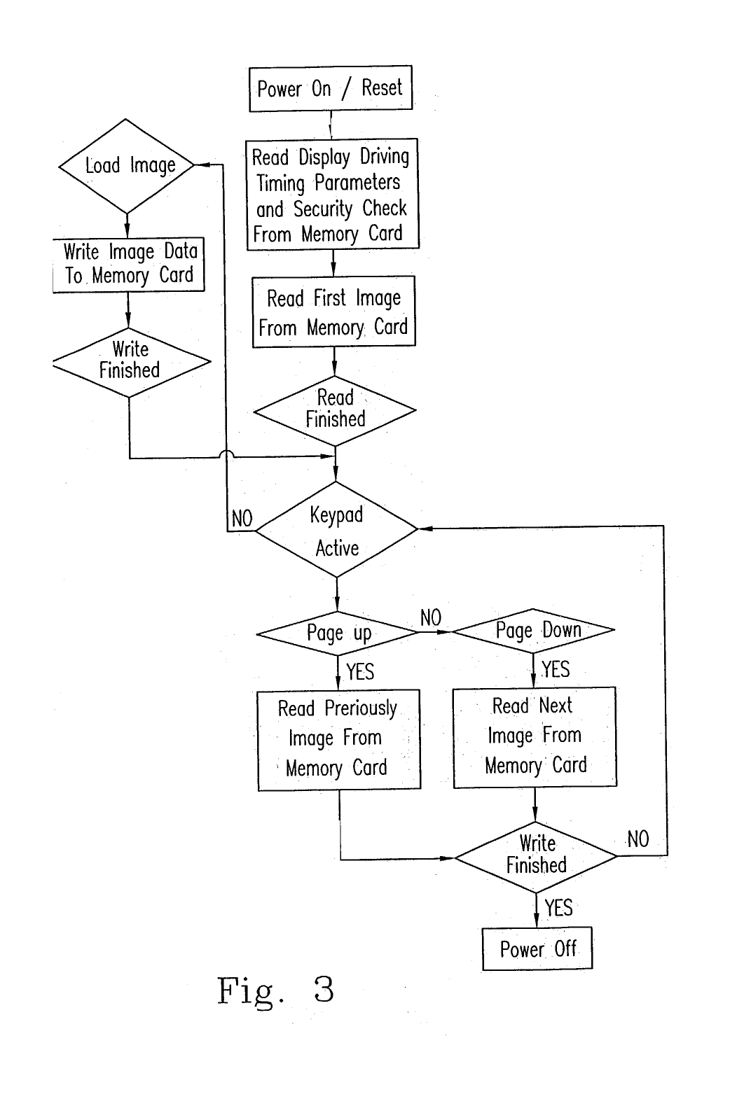

Please refer to FIG. 3 showing the flow chart of the card recognition method of the card recognition module adopting the system integration chip. When the power is on/reset, the card recognition module will automatically detect the specification of the inserted memory card and the stored contents therein and then road the first image data in the memory card. After the reading action, it can be controlled by an input module to decide whether to read the second image data or not. If the input image is continued, as trying to read the previous page, the previous image data in the memory card can be read directly or the next page will be selected directly to read the next image data in the memory card. No matter whether the previous or next pages are read, the power will be off, as the work is completed and the input image will not be continued. Otherwise the key-in instruction of the input module will be waited for again. Particularly, upon trying to download the image data, no action will occur until the image data is stored completely, no matter what instruction are keyed-in by the input module. This method is trying To prevent the inappropriate interruptions, which causes the increases of unnecessary time waste during the download process.

The advantage of the present invention is the card recognition module can be a removable disc. Generally, the transmission of the data about 8-32 MB will need a lot of 1.44 MB diskettes and is also inconvenient. Furthermore, the safety and the transmission speed through the Internet is not good enough, too. But the card recognition module of the present invention can download the data, which is needed to be transmitted to the memory card only through the file manager in the Windows system. Generally, there is no mobile part in the memory card so that the data is safe to be carried and transported. Consequently, the data in the memory curd can be shown as a picture by the display of the card recognition module to get to the function of plug-in and play.

As described above, the card recognition module adopting the system integration chip in the present invention can provide the card recognition function for the card recognition machine in the prior art and furthermore have the display to show the picture of the data in the memory card. The main concept of all the electric equipments is trying to reduce the components and make the functions more complete. Significantly, the present invention can even, by being connected to a person computer externally, provide the data input efficiency. Consequently, the present invention conforms to the demand of the industry and owns inventiveness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system integration chip for display and memory control applied to a card recognition module wherein said card recognition module comprises a module casing, a memory card, an oscillator, a storage, and a displays said system integration chip is disposed in said module casing for recognizing a data stored in said memory card and storing said data in said storage, and said data is converted into a signal by said oscillator and then displayed by said display comprising:
a memory card controller electrically connected to said memory card and said storage to control read and write of said data stored in said memory card.
a data bus controller electrically connected to said memory card, said storage, and said display to control a transmission route for said data; and
a display timing controller electrically connected to said display to control the display condition of said data.

2. A system integration chip according to claim 1 wherein said display is a RAM.

3. A system integration chip according to claim 1 wherein said memory card is a portable memory card.

4. A system integration chip according to claim 1 wherein said module casing is a single module casing.

5. A system integration chip according to claim 1 wherein said recognition module includes an electric equipment.

6. A system integration chip according to claim 5 wherein said electric equipment is a computer.

7. A system integration chip according to claim 6 wherein said memory card is capable of transferring said data to said computer by said system integration chip.

8. A system integration chip according to claim 6 wherein said computer is capable of transferring another data in said computer to said memory card by said system integration chip.

9. A system integration chip according to claim 5 wherein said electric equipment is a printer.

10. A system integration chip according to claim 9 wherein the contents of said data in said memory card is capable of being printed by said printer.

11. A system integration chip according to claim 1 wherein said display timing controller provides a horizontal scanning signal and a vertical scanning signal.

12. A said recognition module, comprising a memory card, an oscillator, a storage, and a display, wherein said data in said memory card is recognized and stored in said storage, said data is converted to said signal by said oscillator, and said signal is displayed by said display, comprising:
a module casing; and
a system integration chip disposed in said module casing, said system integration chip comprising:
a memory card controller electrically connected to said memory card and said storage to control read and write of said data stored in said memory card;
a data bus controller electrically connected to said memory card, said storage, and said display to control a transmission route for said data; and
a display timing controller electrically connected to said display to control the display condition of said data.

13. A card recognition module according to claim 12 wherein said storage is a RAM.

14. A card recognition module according to claim 12 wherein said memory card is a portable memory card.

15. A card recognition module according to claim 12 wherein said module casing is a single module casing.

16. A card recognition module according to claim 12 wherein said card recognition module is an electric equipment.

17. A card recognition module according to claim 16 wherein said electric equipment is a computer.

18. A card recognition module according to claim 17 wherein said memory card is capable of transferring said data to said computer by said system integration chip.

19. A card recognition module according to claim 17 wherein said computer is capable of transferring another data in said computer to said memory card by said system integration chip.

20. A card recognition module according to claim 16 wherein said electric equipment is a printer.

21. A card recognition module according to claim 20 wherein the contents of said data in said memory card is capable of being printed by said printer.

22. A card recognition module according to claim 12 wherein said display timing controller provides a horizontal scanning signal and a vertical scanning signal.

23. A card recognition module, comprising:
a memory card for storing data;
a memory card controller for recognizing said data in said memory card and then storing said data in said storage;
an oscillator electrically connected To said memory card controller for converting said data to a signal;
a data bus controller electrically connected to said memory card controller to control the transmission route of said data;
a display timing controller electrically connected to said display to control the display condition of said data; and
it display electrically connected to said display timing controller to display said data into an image.
